(19) United States
(12) Patent Application Publication
(10) Pub. No.: US 2004/0118976 A1
(43) Pub. Date: Jun. 24, 2004

(54) Secure composite cockpit door and method of manufacture

(76) Inventor: Joseph Albertelli, Temecila, CA (US)

Correspondence Address: MICHAEL E. KLICPERA, PO BOX 573, LA JOLLA, CA, 92038-0573, US

(21) Appl. No.: 10/728,503

(22) Filed: Dec. 5, 2003

Related U.S. Application Data
(60) Provisional application No. 60/432,551, filed on Dec. 10, 2002.

(51) Int. Cl. B64D 11/00; B64D 13/00

(52) U.S. Cl. 244/118.5

(57) ABSTRACT

The present invention disclosed herein is used for replacing or installing a new aircraft cockpit door system in airplanes, wherein such a composite exist as part of the original aircraft structure. In manufacturing a typical cockpit door panel of approximately 0.325″ in thickness, the composition generally comprises a number of independent layers ultra high molecular weight (“U.H.M.W.”) fibers that are of a very dense and treated with phenolic or epoxy resins. In the present invention, three layers with different weaves and resins are used to form a final combination. The first layer section is relatively hard and is constructed from a phenolic resin with a tight fabric weave. The first layer will have the function to deform any pointed projectile to a blunted object. The second layer group is constructed from a relatively softer epoxy resin with a looser fabric weave. This layer functions to form a “delamination” pocket for encouraging the blunted projectile to move “sideways” and interlaminarly having energy absorption properties. The third layer section is relatively hard and is constructed from a phenolic resin with a tight fabric weave. With the projectile having reduced velocity, the third layer functions to captures blunted projectile. This three-layer composite results in an extremely fire resistant, strong, lightweight, yet very hard material.

### CROSS REFERENCES TO RELATED APPLICATIONS

A provisional application for this present invention was filed on Dec. 10,2002 and granted application number 60/432,551.

### FIELD OF THE INVENTION

The field of art to which this invention relates is a design of and method of manufacturing a secure cockpit door for aircraft.

### BACKGROUND OF THE INVENTION

Often a tragic event occurs when terrorist's activities or military events result in the entrance to a relatively non-secure cockpit where the aircraft flight controls are intentionally misaligned or altercated. For a cockpit doors to be secure, it must resist access by forces beyond current locking technology. The most basic requirement is for the cockpit door system to be able to protect the flight crew from gunfire, bomb threats, tampering, and intrusion. In addition, the ideal system must be easy and quick to install, require no aircraft modification, be light-weight, easy to operate, provide rapid egress from the cockpit, meet decompression requirements, meet flame and smoke requirements, reduce extensive and costly research and development, and provide ease of any required certification. The use of fired caliber or small high explosive to destroy or deactivate a securing mechanism must employ technology that is commonly used in bomb containment chambers. Therefore, an additional securing means together with improved materials and technology must be employed to extend the securement of cockpit doors in aircraft.

It is known at this time that an airplane cockpit door will need to possess significant strength characteristics yet be relatively light in weight, therefore, such a cockpit door will be difficult to develop and will require major aircraft modifications.

### SUMMARY OF THE INVENTION

The present invention pertains to composite structures and fabrication methods that currently provide improved composite systems to the aerospace industry. Products built with the materials and methods for bomb containment vessels resulted from the refinement of a proprietary blended laminate composite designed to: 1) distort the geometry of a bullet, 2) slow and deflect a bullet, 3) provide a safety net by delaminating and capturing the bullet, and 4) provide a final barrier with a layer of aramid fibers. Panels of this unique construction underwent ballistic testing using rounds of various size and power specifications: e.g. 0.22 caliber long rifle, 0.38 standard police round, 0.357, 0.45, and 9 MM. Not a single round penetrated and exited the back of the panel and most were captured within the structure of the panel. The aspect of capture and containment of the bullet was a significant attribute of the structure, thus preventing harmful ricochet.

The present invention disclosed herein is used for replacing or installing a new aircraft cockpit door system in airplanes, wherein such a composite exist as part of the original aircraft structure. In manufacturing a typical panel of approximately 0.325″ in thickness, the composition generally comprises a number of independent layers of resin treated ultra high molecular weight (“U.H.M.W.”) fibers that are of a very dense.

In the present invention, three layers with different weaves and resins are used to form a final combination. The first layer section is relatively hard and is constructed from a phenolic resin with a tight weave. The first layer will have the function to deform any pointed projectile to a blunted object. The second layer group is constructed from a relatively softer epoxy resin with a looser weave. This layer functions to form a “delamination” pocket for encouraging the blunted projectile to move “sideways” and interlaminarly having energy absorption properties. The third layer section is relatively hard and is constructed from a phenolic resin with a tight weave. With the projectile having reduced velocity, the third layer functions to captures blunted projectile. This three-layer composition results in an extremely fire resistant, strong, lightweight, yet very hard material.

After the raw molding of the present invention is produced it would be appropriately trimmed and drilled to accept typical aircraft titanium hardware.

For final applications, the present invention would receive a “TEDLAR” (aircraft approved) decorative laminate for typical appearance.

### BRIEF DESCRIPTION OF THE DRAWINGS

The invention can be better understood by reference to the following description, taken in connection with the accompanying drawings.

FIG. 1 is a perspective view of a passenger aircraft with the general position of the secure cockpit door assembly.

FIG. 2 is a perspective view of the fabrication process for manufacturing the three layer composite structure.

FIG. 3 is a simplified schematic top view of a laminate composite secure cockpit door with associated closing mechanism, position indicator, sensor equipment, and locking mechanism.

FIG. 4 is a simplified schematic front side of the secure cockpit door for modification to an existing structure for an aircraft of FIG. 1.

FIG. 5 is an exploded view of the composite layers used to fabricate the secure cockpit door assembly.

### DESCRIPTION OF THE PREFERRED EMBODIMENT

The present invention pertains to composite structures and fabrication methods that currently provide improved composite systems to the aerospace industry.

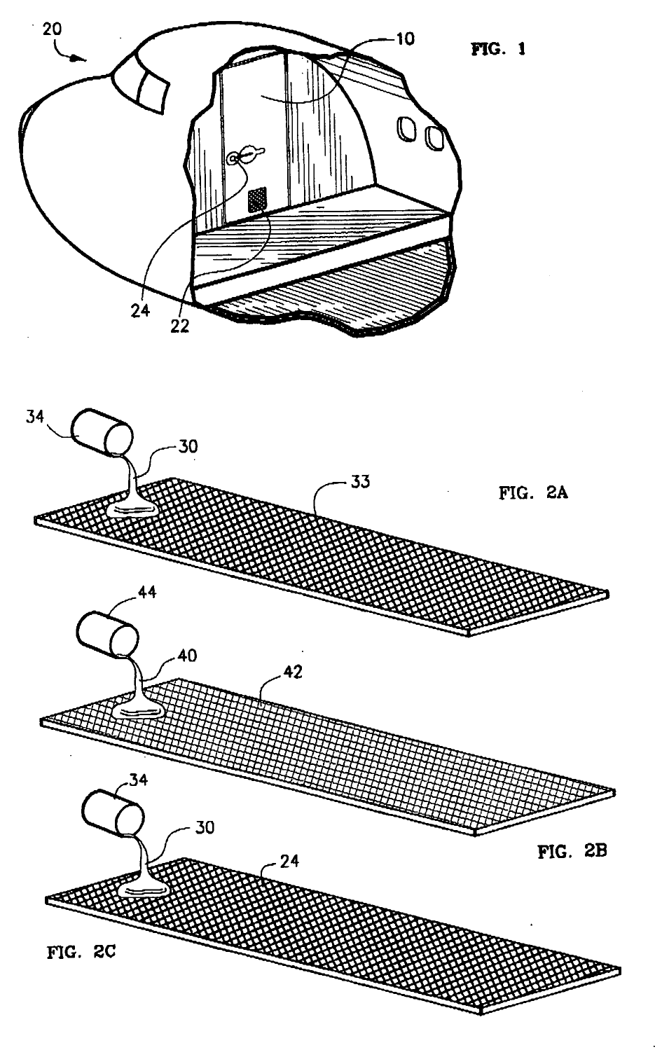

As shown in FIG. 1, the present invention disclosed herein is used for replacing or installing in new aircraft, a cockpit door system, wherein a specific composite structure exists, in modifying aircraft, as part of the original aircraft structure. FIG. 1 is an angled front view demonstrating the relative positioning of various components of a modified secure cockpit door, with the secure panel replacing the existing door of a typical aircraft. The present invention shown here, for example, is a format for the McDonald-Douglas (MD) 80 aircraft. While using the MD 80 as an example, the Applicant asserts that the present invention secure cockpit door could be used for a variety of aircrafts. Furthermore, while it is generally described herein that the existing aircraft door will be modification by the present invention secure cockpit door, it is anticipated by the Applicant that this present invention could be used or employed with newly manufactured aircraft.

In manufacturing a typical panel of approximately 0.325″ in thickness, the composition generally comprises a number of layers of resin treated with ultra high molecular weight (“U.H.M.W.”) fibers that are of a very dense weave. The fibers are composed of either a relatively tight or loose weaves that are specially “sized” and chemically plasma treated for the bonding with a matrix resin binder. As an example, the present invention utilizes a “SPECTRA” cloth or “SPECTR-SHIELD” that is manufactured from a gel spun polyethylene under the trade name Dynema®, which is fabricated by Allied Signal Corporation. This raw polyethylene fiber, is spun while in a gel form, that results in a crystalline substance is one of the strongest fibers manufactured. It is contemplated by the Applicant the other manufactures and suppliers of the U.H.M.W. polyethelene plastic can be utilized with the present invention. The U.H.M.W. polyethelene plastic is then drawn into fibers and bundled into an approximately one to three thousand strand “yarn”. The yarn is then plasma treated to accept bonding agents, and finally woven into the fabric form and stored on rolls.

After the looming and the pre-treatment processes, the layer is constructed by impregnation of the resin under computer-controlled conditions (See FIG. 2). The resin binder that is employed consists from a group of either a phenolic or epoxy resin based material that exhibits thermosetting plastic properties for the application. Typical phenolic resins are specified in MIL-R-9299. Typical epoxy resins are specified in MIL-R-9300.

Then the specific number of layers of the U.H.M.W./phenolic and epoxy composite are then treated with a pressure of 25-35 p.s.i. and heated to a range of 300-400 degrees Fahrenheit for approximately 10-45 minutes until the material cures. The pressure, heat and temperature range may be adjusted for various factors, such as number of layers. Furthermore, additional heat treatments may be employed to further modify the composition to achieve certain characteristics.

In the present invention, three layers with different weaves and resins are used to form a final combination.

As shown in FIG. 2a, the first composite layer 36 is constructed from a tight weave of the U.H.M.W. polyethelene plastic fabric 32 that is impregnated with a phenolic resin 30 taken from a properly stored container 34. The tight weave of the U.H.M.W. polyethelene plastic fabric consists of approximately 20 layers of 0.005″ thick 1 thousand plain Dynema fabric. An example of the phenolic resin 30 is MW114 made by Capital Resin Corp., and distributed by D.M.C. in San Diego, Calif. The first composite layer 32 is relatively hard and will have the function to deform any pointed projectile to a blunted object.

As shown in FIG. 2b, the second composite layer 46 is constructed from a loose weave of the U.H.M.W. polyethelene plastic fabric 42 (e.g. Dynema fabric) and impregnated with a relatively softer epoxy resin 40 taken from a properly stored container 44. The loose weave of the U.H.M.W. polyethelene plastic fabric 42 consists of approximately 5 layers of 0.020″ thick 3 thousand 8HS Dynema fabric. An example of the epoxy 40 is MIL-R-9300. This layer functions to form a “delamination” pocket for encouraging the blunted projectile to move “sideways” and interlaminarly having energy absorption properties.

As shown in FIG. 2c, the third composite layer 36 is constructed from a tight weave of the U.H.M.W. polyethelene plastic fabric 32 that is impregnated with a phenolic resin 30 taken from a properly stored container 34. The tight weave of the U.H.M.W. polyethelene plastic fabric 32 consists of approximately 20 layers of 0.005″ thick 1 thousand plain Dynema fabric. An example of the phenolic resin 30 is MW114 made by Capital Resin Corp., and distributed by D.M.C. in San Diego, Calif. The third composite layer 32 is relatively hard and will have the function to capture any blunted projectile.

After a specific time allowed for curing, the three layer composite structure are then treated with a pressure in the range of 15 to 50 p.s.i., and more specifically in the range of 25-35 p.s.i., and heated to a range of approximately 300-400 degrees Fahrenheit for approximately 10-45 minutes until the material cures. The pressure, heat and temperature ranges may be adjusted for various factors, such as different requirements for resins fabricated by various manufactures. Furthermore, additional heat treatments may be employed to further modify the composition to achieve certain characteristics.

The hardness of the matrix resins in combination with the tough flexibility of the specific fibers results in a three layer composite structure that provides a secure panel having the following capabilities: causing a projectile to initially deform (mushroom) thereby increasing the projectile's surface area; causing the projectile's energy to be taken up by the plasticity of the fibers; and as the projectile expands it will locally delaminate a few of the outer layers of the panel and will become captured.

FIG. 3 is a top view representation of an aircraft's door showing the laminated composite structure of the secure cockpit door assembly 10 attached to the existing door 12. Also demonstrated is the associated closing/locking mechanism 24.

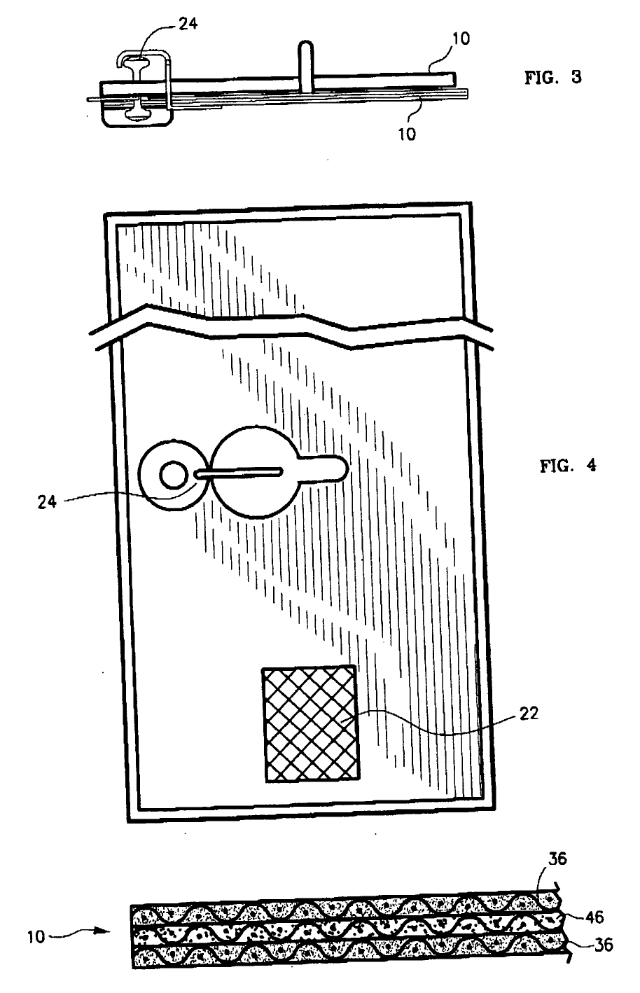

FIG. 4 demonstrates a front (inside) view of the secure cockpit door attached to an existing aircraft door as depicted in FIG. 1. Also demonstrated are associated closing/locking mechanism 24, potential position indicator and sensor equipment (not shown), and vent 22.

As shown in FIG. 5, the present invention results in a three-layer composition that is extremely fire resistant, strong, lightweight, yet very hard material. The actual laminate stack of the present invention is a sequence as follows:

1- (1) layer FAA approved decorative laminate;

2- (20) layers of 0.005″ thick 1 thousand plain U.H.M.W. polyethelene plastic fabric impregnated with a phenolic resin matrix;

3- (5) layers of 0.020″ thick 3 thousand 8HS U.H.M.W. polyethelene plastic fabric impregnated with a epoxy resin matrix;

4- (20) layers of 0.005″ thick plain the U.H.M.W. polyethelene plastic fabric impregnated with phenolic resin matrix;

5- (1) layer decorative laminate (for new aircraft applications) or an adhesive panel (for modified aircraft applications);

This composite structure results in a total nominal panel thickness in the range of 0.025″ to 0.050″ thick, and preferably approximately 0.325″ thick.

After the raw molding is produced it would be appropriately trimmed and drilled to accept typical titanium hardware.

For final applications, the present invention would receive a FAA aircraft approved decorative laminate for typical appearance. Such laminates typically come under the trademark name “TEDLAR”.

I claim:

1. A secure composite door assembly for protecting flight crew in an aircraft, said flight crew having a cockpit area and a passenger area, and said composite door providing securement between said cockpit area and said passenger area, said composite door assembly comprising:
at least one layer adjacent to the passenger area comprised of a ultra-high molecular weight polyethylene fabric impregnated with a phenolic resin matrix resulting in a first layer whereby said first layer functions to blunt sharp projectiles;
at least one layer of ultra-high molecular weight polyethylene fabric impregnated with an epoxy resin matrix resulting in a second layer, said second layer located and between said first layer or layers and a third layer or layers adjacent to the cockpit area, whereby said second layer functions to absorb energy properties of blunted projectiles; and
at least one layer adjacent to the cockpit area comprised of ultra-high molecular weight polyethylene fabric impregnated with a phenolic resin matrix resulting in a third layer, whereby said third layer functions to capture blunted projectiles.

2. The security composite door assembly according to claim 1, wherein said ultra-high molecular weight polyethylene fabric resulting in a first layer comprises a dense weave.

3. The security composite door assembly according to claim 1, wherein said ultra-high molecular weight polyethylene fabric resulting in a second layer comprises a loose weave.

4. The security composite door assembly according to claim 1, wherein said ultra-high molecular weight polyethylene fabric resulting in a third layer comprises a dense weave.

5. The security composite door assembly according to claim 1, further comprising a laminate layer secured to a passenger facing surface of said first layer.

6. The security composite door assembly according to claim 1, wherein said door assembly is appropriately trimmed and drilled for retrofitting upon existing aircraft cockpit doors.

7. The security composite door assembly according to claim 1, wherein the door assembly are, at least in part, transparent.

8. A method for improving the security of an aircraft door comprising the steps of:
preparing the existing cockpit door from an aircraft to accept a secure composite door assembly;
installing a secure cockpit door which consists of at least one layer adjacent to the passenger area comprised of fabric impregnated with a phenolic resin matrix, at least one layer adjacent to the cockpit area comprised of fabric impregnated with a phenolic resin matrix, and at least one layer of 8HS fabric impregnated with an epoxy resin matrix located between said layer or layers adjacent to the passenger area and said layer or layers adjacent to the cockpit area.

9. An improved cockpit door for aircraft, said cockpit door comprising:
at least one layer adjacent to the passenger area comprised of ultra-high molecular weight polyethylene fabric impregnated with a phenolic resin matrix;
at least one layer adjacent to the cockpit area comprised of ultra-high molecular weight polyethylene fabric impregnated with a phenolic resin matrix; and
at least one layer of ultra-high molecular weight polyethylene fabric impregnated with an epoxy resin matrix located between said layer or layers adjacent to the passenger area and said layer or layers adjacent to the cockpit area.

10. A method of manufacturing a secure composite door comprising the steps of:
impregnating at least one ultra-high molecular weight polyethylene fabric with a phenolic resin creating a first composite layer;
applying pressure and heat in the range of 300 to 400 degrees Fahrenheit to said first composite layer;
impregnating at least one ultra-high molecular weight polyethylene fabric with a epoxy resin creating a second composite layer;
combining said first layer with said second composite layer creating a first composite assembly with one side exposing said first composite layer and the other side exposing said second composite layer;
applying pressure and heat in the range of 300 to 400 degrees Fahrenheit to said combined first composite and second composite layer creating a second composite assembly;
impregnating at least one ultra-high molecular weight polyethylene fabric with a second resin creating a third composite layer;
combining said third layer with said second composite layer side of said second composite assembly; and
applying pressure and heat in the range of 300 to 400 degrees Fahrenheit to said combined first composite assembly and third composite layer to form a third composite assembly.

11. The method of manufacturing a secure composite door according to claim 10, further comprising the step of applying laminate at least one side of the second composite assembly to form a finished composite assembly.

12. The method of manufacturing a secure composite door according to claim 10, further comprising the step of applying laminate at least one side of the second composite assembly to form a finished composite assembly.

13. The method of manufacturing a secure composite door according to claim 10, further comprising the step of trimming the finished composite assembly and drilling holes for affixing hardware.

14. A method of manufacturing a secure composite door comprising the steps of:
impregnating at least one ultra-high molecular weight polyethylene fabric with a phenolic resin creating a first composite layer;
impregnating at least one ultra-high molecular weight polyethylene fabric with a epoxy resin creating a second composite layer;
combining said first layer with said second composite layer creating a first composite assembly with one side exposing said first composite layer and the other side exposing said second composite layer;
impregnating at least one ultra-high molecular weight polyethylene fabric with a second resin creating a third composite layer;
combining said third layer with said second composite layer side of said first composite assembly; and
applying pressure and heat in the range of 300 to 400 degree Fahrenheit to said combined first composite assembly and third composite layer to form a second composite assembly.

15. The method of manufacturing a secure composite door according to claim 14, further comprising the step of applying pressure and heat in the range of 300 to 400 degrees Fahrenheit to said first composite layer.

16. The method of manufacturing a secure composite door according to claim 14, further comprising the step of applying pressure and heat in the range of 300 to 400 degrees Fahrenheit to said first composite assembly.

17. A secure composite assembly comprising:
at least one layer comprised of a ultra-high molecular weight polyethylene densely woven fabric impregnated with a phenolic resin matrix resulting in a first layer whereby said first layer functions to blunt sharp projectiles;
at least one layer of ultra-high molecular weight polyethylene loosely woven fabric impregnated with an epoxy resin matrix resulting in a second layer, said second layer located and between said first layer or layers and a third layer or layers, whereby said second layer functions to absorb energy properties of blunted projectiles; and
at least one layer adjacent to the cockpit area comprised of ultra-high molecular weight polyethylene densely woven fabric impregnated with a phenolic resin matrix resulting in a third layer, whereby said third layer functions to capture blunted projectiles.
